(19) United States
(12) Patent Application Publication
(10) Pub. No.: US 2020/0163418 A1
(43) Pub. Date: May 28, 2020

(54) WEB ADJUSTER

(71) Applicant: Shield Restraint Systems, Inc., Elkhart, IN (US)

(72) Inventor: Phillip Dale Morgan, Noblesville, IN (US)

(21) Appl. No.: 16/203,529

(22) Filed: Nov. 28, 2018

(51) Int. Cl. A44B 11/12; A44B 11/10; A44B 11/14; A44B 11/06

(52) U.S. Cl. CPC A44B 11/125; A44B 11/10; B60N 2/2809; A44B 11/065; A44B 11/14

(57) ABSTRACT

Web adjusters for use with occupant restraint systems are described herein. In some embodiments, a web adjuster can include first and second cross bars that are operably coupled to a frame, and a release member that is pivotally coupled to the frame and configured to cooperate with the second cross bar. In use, a web can be routed through the web adjuster so that it passes between the first and second cross bars. A user can increase tension in the web by pulling on a free end of the web. When the free end of the web is released, it drives the first cross bar toward the second cross bar to fixedly clamp the web therebetween and maintain the tension in the web. To release the tension in the web, the user can rotate the release member away from the frame, which in turn enables the second cross bar to move away from the first cross bar, thereby enabling the web to pass between the two cross bars and through the adjuster.

### TECHNICAL FIELD

The present disclosure is generally directed to web adjusters for use with seat belts and other webs.

### BACKGROUND

Personal restraint systems for use in automobiles and other vehicles are well known. Such systems can include, for example, seat belts for use by adults and children of sufficient size, and child seats for use with smaller children and toddlers.

Conventional child seats are typically configured to be mounted on a passenger seat in an automobile or other vehicle. Such child seats are typically secured to the passenger seat by one or more belts or webs that extend from the child seat to a corresponding anchor point in the vehicle. The length and tension in the web is typically adjusted by use of a web adjustor that joins two sections of web together. Examples of web adjusters are disclosed in, for example, U.S. Pat. Nos. 5,160,186 and 3,872,550, and U.S. patent application Ser. No. 15/890,239, titled “WEB ADJUSTER” and filed on Feb. 6, 2018, each of which is incorporated herein by reference in its entirety.

In general, web adjusters enable a user to increase tension in a web by pulling a free end of the web through the adjuster, and release tension in the web by manually releasing or “unlocking” the adjuster. Some conventional web adjusters, however, require considerable force to manually unlock the adjuster, especially when the web is under full tension. Accordingly, it would be advantageous to provide a web adjuster that requires a relatively low force to unlock.

### BRIEF DESCRIPTION OF THE DRAWINGS

FIG. 1A is an isometric view of a web adjuster configured in accordance with embodiments of the present technology, and FIGS. 1B-1D are a series of partially exploded isometric views of the web adjuster.

FIGS. 2A-2D are a series of side cross-sectional views illustrating operation of the web adjuster of FIGS. 1A-1D in accordance with embodiments of the present technology.

FIG. 3 is a side view of a child seat secured to a vehicle seat with a restraint system having a web adjuster configured in accordance with embodiments of the present technology.

### DETAILED DESCRIPTION

The following disclosure describes various embodiments of web adjusters for use with child seats and/or other personal restraint systems in automobiles and other vehicles. In some embodiments, a web adjuster configured in accordance with the present technology can include first and second cross bars that are configured to be positioned on opposite sides of a web routed around the first cross bar and through the web adjuster. The web adjuster can further include a release member having at least one cam surface. When the release member is in a first (e.g., a locked) position, the cam surface prevents the second cross bar from moving away from the first cross bar. As a result, when a user pulls a free end portion of the web through the adjuster, it increases the tension in the web and draws the first cross bar toward the second cross bar, clamping the web therebetween. Moving (e.g., rotating) the release member away from the first position toward a second (e.g., an unlocked) position moves the cam surface away from the second cross bar. This enables the second cross bar to move away from the first cross bar, thereby releasing the web so that it can move between the two cross bars and release the tension in the web. These and other features of web adjusters configured in accordance with embodiments of the present technology are described in greater detail below.

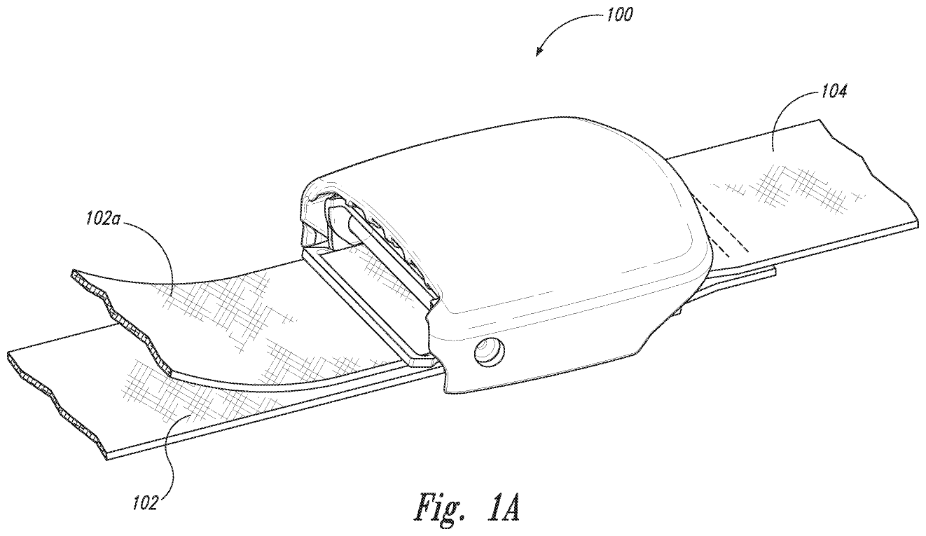

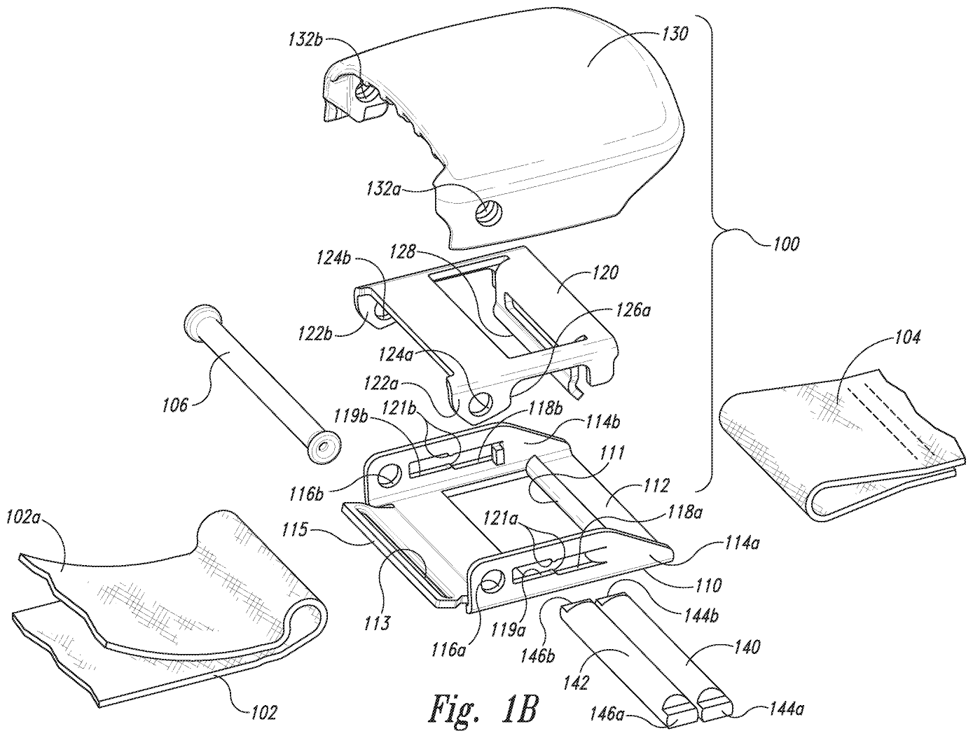

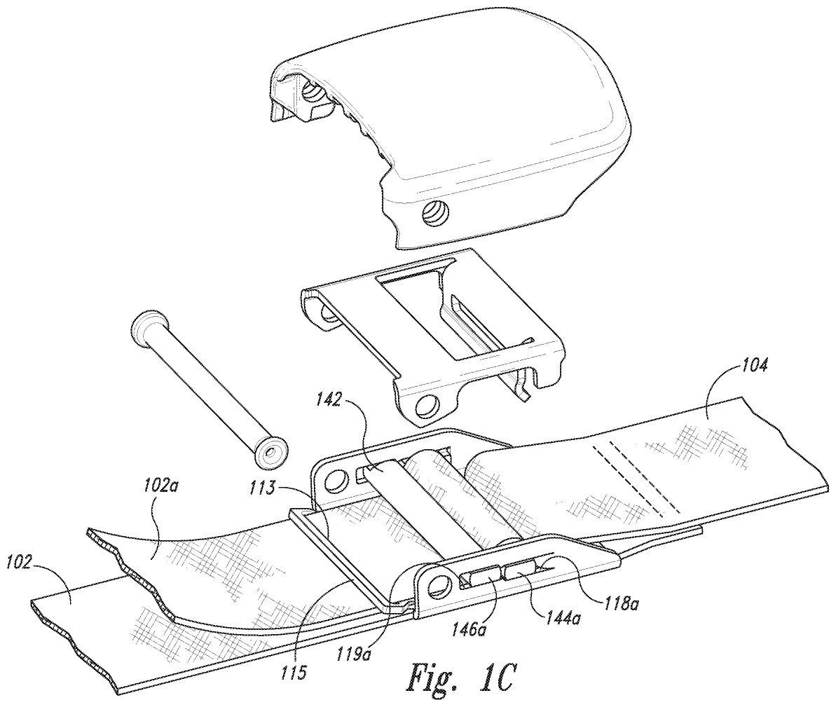

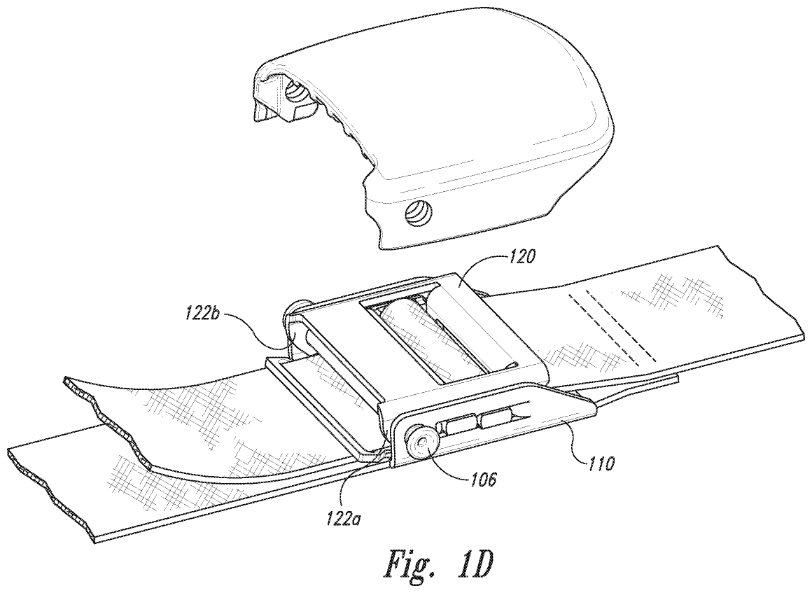

Certain details are set forth in the following description and in FIGS. 1A-3 to provide a thorough understanding of various embodiments of the present technology. In other instances, well-known structures, materials, operations and/or systems often associated with web adjusters, seat belt webs, child seats and/or other personal restraint system hardware are not shown or described in detail in the following disclosure to avoid unnecessarily obscuring the description of the various embodiments of the technology. Those of ordinary skill in the art will recognize, however, that the present technology can be practiced without one or more of the details set forth herein, or with other structures, methods, components, and so forth.

The accompanying Figures depict embodiments of the present technology and are not intended to be limiting of its scope. The sizes of various depicted elements are not necessarily drawn to scale, and these various elements may be arbitrarily enlarged to improve legibility. Component details may be abstracted in the Figures to exclude details such as position of components and certain precise connections between such components when such details are unnecessary for a complete understanding of how to make and use the invention. Many of the details, dimensions, angles and other features shown in the Figures are merely illustrative of particular embodiments of the disclosure. Accordingly, other embodiments can have other details, dimensions, angles and features without departing from the scope of the present invention. Those of ordinary skill in the art will also appreciate that further embodiments of the invention can be practiced without several of the details described below.

In the Figures, identical reference numbers identify identical, or at least generally similar, elements. To facilitate the discussion of any particular element, the most significant digit or digits of any reference number refers to the Figure in which that element is first introduced. For example, element 110 is first introduced and discussed with reference to FIG. 1.

FIG. 1A is an isometric view of a web adjuster 100 configured in accordance with embodiments of the present technology, and FIGS. 1B-1D are a series of partially exploded isometric views of the web adjuster 100. Referring first to FIGS. 1A and 1B together, the web adjuster 100 can be used to operably join a first web 102 (e.g., an “adjust web”) to a second web 104 (e.g., an “anchor web”). The web adjuster 100 includes a frame 110 having a first side wall 114a and a second side wall 114b extending upwardly from opposite sides of a base 112. The base 112 includes a first web aperture 111 and a second web aperture 113 in a web guide portion 115. The first side wall 114a includes a first opening defined by a first slot portion 118a and a third slot portion 119a. Similarly, the second side wall 114b includes a second opening defined by a second slot portion 118b and a fourth slot portion 119b. In the illustrated embodiment, the individual slot portions 118a,b, and 119a,b are generally rectangular in shape and parallel, or at least approximately parallel, to the base 112. Additionally, the third and fourth slot portions 119a,b are slightly offset or “stepped” relative to the corresponding first and second slot portions 118a,b so that the respective slot portions 118a, 119a and 118b, 119b are not longitudinally aligned. For example, in some embodiments the third and fourth slot portions 119a,b can be offset from the corresponding first and second slot portions 118a,b by about 0.005 inch to about 0.08 inch, or about 0.01 inch to about 0.06 inch, in the direction away from the base 112. The first side wall 114a also includes a pair of opposing ridges or protuberances 121a that partially separate the first slot portion 118a from the third slot portion 119a. Similarly, the second side wall 114b includes a pair of opposing protuberances 121b that partially separate the second slot portion 118b from the fourth slot portion 119b. In addition to the foregoing features, the first side wall 114a further includes a first pin hole 116a, and the second side wall 114b includes a corresponding second pin hole 116b.

The web adjuster 100 further includes a first cross bar 140 (e.g., a “sliding bar”) and a second cross bar 142 (e.g., a “locking bar”). In the illustrated embodiment, each of the cross bars 140 and 142 can have a cylindrical (e.g., round) cross-sectional shape and can be identical, or at least generally similar in structure and function. More specifically, the first cross bar 140 can include a first end portion 144a and a second, opposite end portion 144b. Similarly, the second cross bar 142 can include a first end portion 146a and a second, opposite end portion 146b. In some embodiments, each of the end portions 144a,b and 146a,b can have a generally rectangular shape configured to be slidably received in the corresponding slot portions 118a,b and 119a,b, respectively, in the side walls 114a,b. More specifically, referring to FIGS. 1B and 1C together, the first end portion 144a of the first cross bar 140 is configured to be slidably received in the first slot portion 118a, and the second end portion 144b of the first cross bar 140 is configured to be slidably received in the second slot portion 118b. Similarly, the first end portion 146a of the second cross bar 142 is configured to be slidably received in the third slot portion 119a, and the second end portion 146b of the second cross bar 142 is configured to be slidably received in the fourth slot portion 119b.

By “slidably received” it should be understood that the end portions 144a,b and 146a,b are received in the corresponding slot portions 118a,b and 119a,b, respectively, in such a way that they can move (e.g., “slide”) fore and aft in the respective slot portions a certain distance (e.g., a distance of from about 0.02 inch to about 0.2 inch, or from about 0.03 inch to about 0.12 inch, or from about 0.04 inch to about 0.1 inch) without substantial rotation. The protuberances 121a and 121b are configured to limit forward movement of the first cross bar 140 and aft movement of the second cross bar 142, while still allowing the two cross bars to move sufficiently close to each other (e.g., to contact each other) to clamp a web therebetween. Additionally, in some embodiments the slight offset between the slot portions 118a and 119a, and the slot portions 118b and 119b can facilitate web clamping and/or movement of the web relative to the first cross bar 140 and the second cross bar 142. In other embodiments, the slot portions 118a,b and 119a,b, the cross bars 140 and 142, and/or the end portions 144a,b and 146a,b can have other shapes and configurations. For example, in some embodiments the protuberances 121a can be connected so that the slot portions 118a and 119a are fully separated, and similarly the protuberances 121b can be connected so that the slot portions 118b and 119b are fully separated. In these embodiments, the end portions 144a,b and 146a,b may have different shapes and/or sizes (e.g., square shapes) to provide the desired range of movement described above. In yet further embodiments, the slight offset of the slot portions 119a,b relative to the slot portions 118a,b may be omitted so that slot portions 118a,b and 119a,b are longitudinally aligned (and, e.g., parallel to the base 112).

As shown in FIG. 1C, first web 102 can be routed through the first web aperture 111, around the first cross bar 144a, and then between the first cross bar 144a and the second cross bar 146a before passing through the second web aperture 113 in the guide portion 115. The second web 102 includes a free end portion 102a and an opposite end (not shown) that is spaced apart from the web adjuster 100. As described in greater detail below, the opposite end of the first web 102 can be secured to, for example, a child seat. The second web 104 can be looped through the first web aperture 111 before being stitched or otherwise attached to itself to securely attach the second web 104 to the frame 110. As also described in greater detail below, the opposite end of the second web 104 (e.g., the “tag end”) can carry, for example, a latch or other connecting device to fixedly attach the second web 104 to an anchor or other structure in a vehicle. Together, the first web 102 and the second web 104 can form a combined web that secures the child seat to the vehicle. The webs 102 and 104 can be any type of conventional restraint straps, seat belt webs, etc. well known in the art, and can be constructed of various suitable materials known in the art, such as woven nylon.

Returning to FIG. 1B, the web adjuster 100 further includes a release member 120 (e.g., a “release lever” or “lift lever”) having a first side flange 126a spaced apart from a second side flange 122b. In the illustrated embodiment, the side flanges 122a,b are mirror images of each other and each includes a corresponding pin hole 124a,b and a corresponding cam surface portion 126a,b. Each of the cam surface portions 126a,b have a partially rounded portion that, as described in greater detail below, is complementary to and configured to cooperate with the second cross bar 142. The release member 120 further includes a rear wall portion 128 that extends generally downward from an aft portion of the release member 120 between the first side flange 126a and the second side flange 126b.

Referring next to FIGS. 1B and 1D together, the release member 120 is pivotally coupled to the frame 110 by means of a pivot pin 106 that extends through the pin holes 124a,b in the release member 120 and the corresponding pin holes 116a,b in the frame 110. As shown in FIG. 1D, the side flanges 122a,b of the release member 120 are positioned inside the side walls 114a,b of the frame 110 when the release member 120 is in the “locked” position. A cover 130 can be mounted to the release member 120 to facilitate manual operation of the web adjuster 100. More specifically, in the illustrated embodiment the cover 130 can be configured to “snap” over or otherwise fit onto and attach to the release member 120 so that a user can manually grasp the cover 130 and move the cover 130/release member 120 to or from the locked position shown in FIGS. 1A and 1D.

The components of the web adjuster 100 described above can be manufactured using various suitable materials and methods well known in the art. For example, the frame 110 and the release member 120 can be formed from a suitably strong metal, such as a plate steel, that is stamped or otherwise cut and then bent or otherwise formed to shape. The cross bars 140 and 142, and the pivot pin 106, can also be formed from a suitable metal, such as steel that is machined, forged, cast, etc. In some embodiments, the cover 130 can be formed from a suitable plastic material, such as injection molded plastic. In other embodiments, the foregoing components can be manufactured using other suitable materials and methods known in the art.

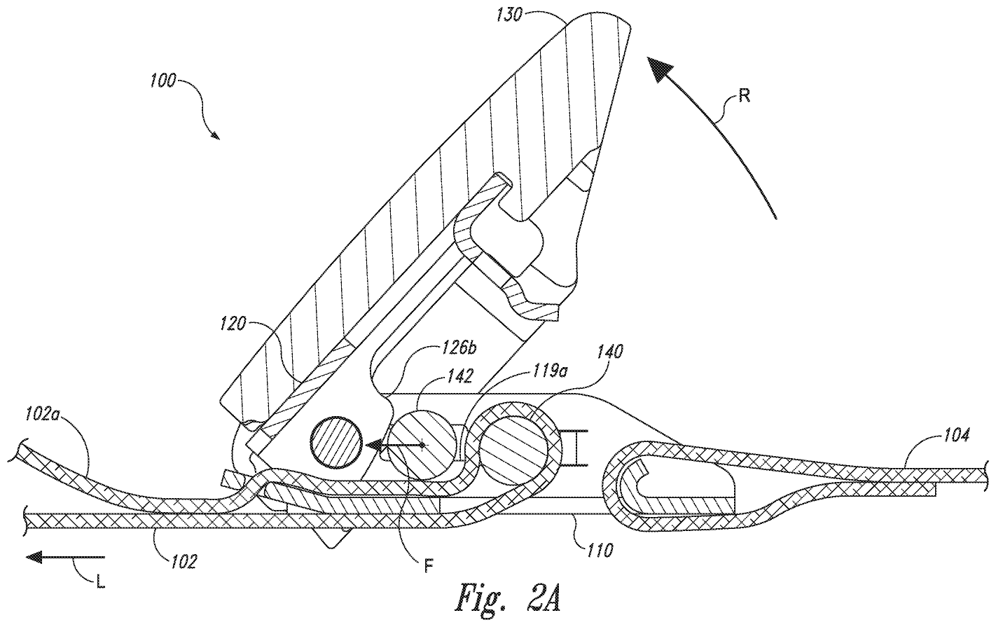

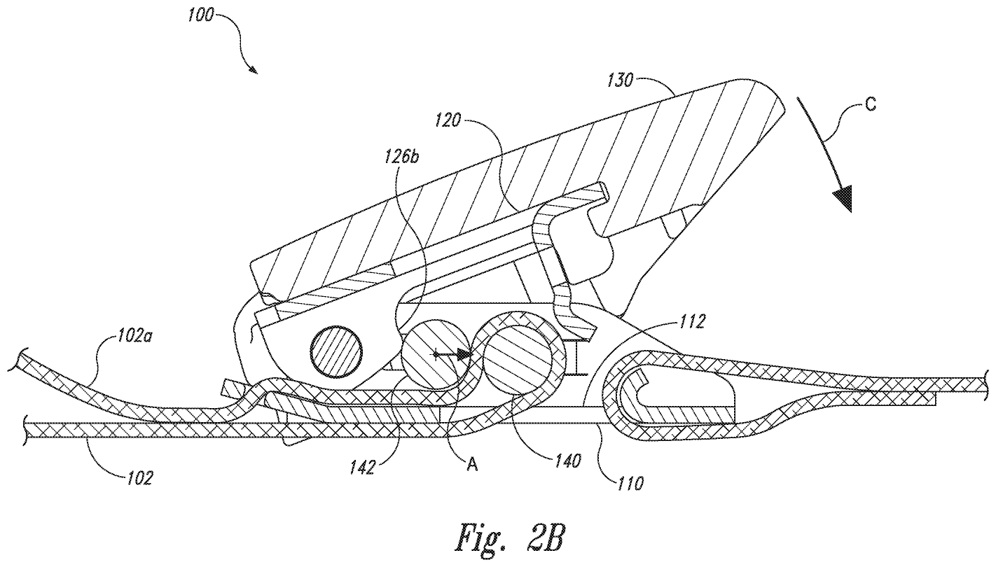

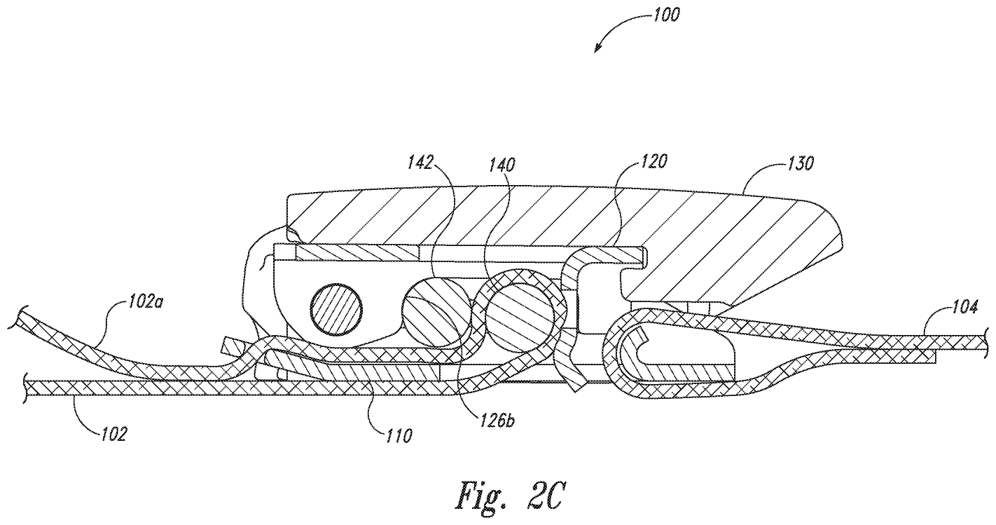

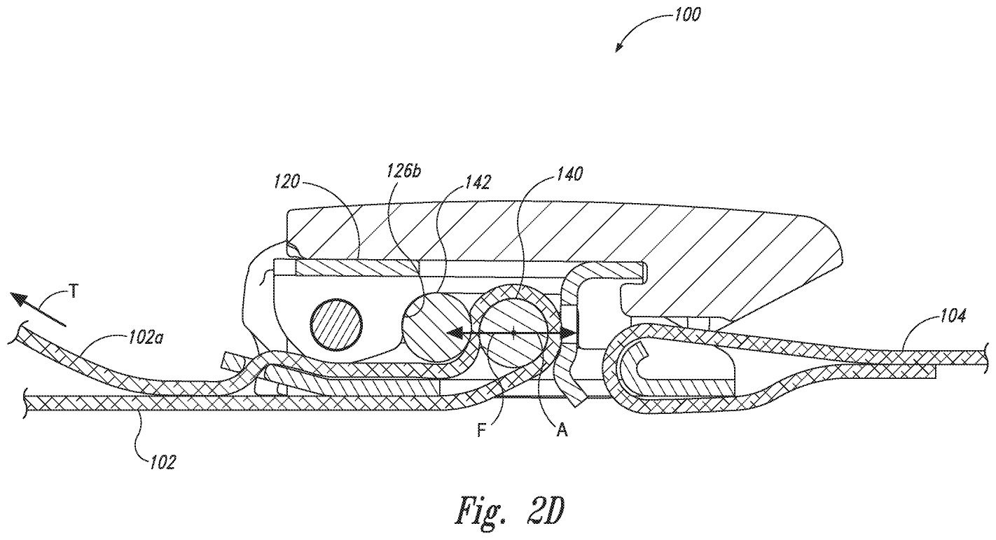

FIGS. 2A-2D are a series of side cross-sectional views illustrating various stages of operation of the web adjuster 100 in accordance with embodiments of the present technology. In FIG. 2A, the cover 130 (and, more specifically, the release member 120) has been rotated away from the frame 110 in direction R to a “release” position. In this position, the cam surface portions 126a,b (only the second cam surface portion 126b is shown in the cross-section view of FIG. 2A) are moved away from the second cross bar 142. This enables the second cross bar 142 to slide slightly forward in direction F in the slot portions 119a,b (FIG. 1B) and increase the distance between the second cross bar 142 and the first cross bar 140. This in turn unclamps the second web 102 and, if the second web 102 is under tension, it pulls through the web adjuster 100 in direction L, thereby reducing tension in the first and second webs 102 and 104.

Turning next to FIG. 2B, when the user wishes to “lock” the web adjuster 100, the user can do so by rotating the release member 120 toward the frame 110 in direction C. As the cam surface portions 126a,b on the release member 120 approach the base 112 of the frame 110, the cam surface portions 126a,b contact the second cross bar 142 and drive it aft in direction A toward the first cross bar 140, thereby reducing the gap between the first cross bar 140 and the second cross bar 142. As shown in FIG. 2C, when the release member 120 is fully closed, the cam surface portions 126a,b fit firmly against the second cross bar 142 and prevent it from moving away from the first cross bar 140.

Referring next to FIG. 2D, to fully lock the web adjuster 100, the user pulls the free end portion 102a of the first web 102 through the second web aperture 113 in direction T. Doing this can initially drive the first cross bar 140 away from the second cross bar 142 in direction A to slightly increase the space therebetween as the slack is taken out of the first web 102 and the tension is increased. When the user releases the free end portion 102a, the tension in the web 102 drives the first cross bar 140 back in direction F against the second cross bar 142 to clamp the web 102 in position and maintain the tension in the first and second webs 102 and 104. In this configuration, the web adjuster 100 is fully “locked” and the webs 102 and 104 can carry their full operating loads without losing tension. When the user wishes to unlock the web adjuster 100 and relieve the tension in the webs 102 and 104, the user can rotate the release member 120 away from the frame 110 in the direction R as shown in FIG. 2A which, as explained above, enables the second cross bar 142 to move away from the first cross bar 140 in direction F so that the web 102 can pass therebetween in direction L.

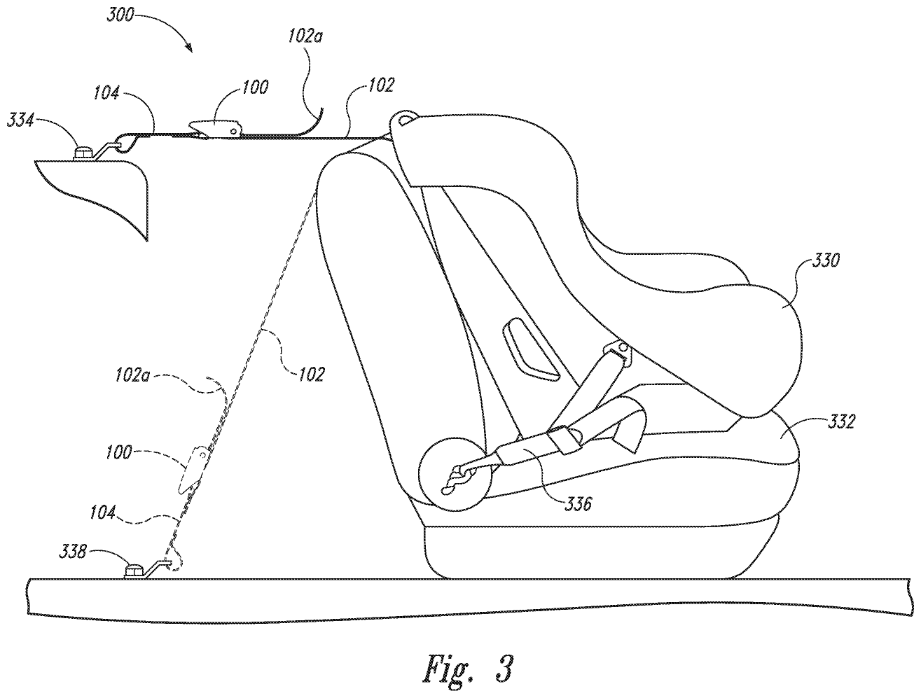

The web adjuster 100 described in detail above can be used in a wide variety of applications. FIG. 3, for example, is a side view of a child seat 330 secured in a car seat 332 with a restraint system 300 that includes the web adjuster 100. In the illustrated embodiment, an upper portion of the child seat 330 is securely attached to an upper anchor 334 in a vehicle (e.g., a car) by means of the first web 102 and the second web 104, which are coupled together by the web adjuster 100. Although the upper portion of the child seat 330 is secured to the upper anchor 334, as those of ordinary skill in the art will understand, in other embodiments the upper portion of the child seat 330 and/or other portions of the child seat 330 can be secured to a lower anchor 338 by means of the webs 102 and 104 and the web adjuster 100. A lower portion of the child seat 330 can be secured to the car seat 332 with additional restraints, such as a restraint 336 of a type well known to those of ordinary skill in the art. In other embodiments, the web adjuster 100 can be used with various other web arrangements without departing from the present disclosure.

Referring to FIGS. 2A-3 together, in operation a user can increase the tension in the first web 102 and the second web 104 by grasping the free end portion 102a and pulling it in the direction T as described above with reference to FIG. 2D. When the user releases the free end portion 102a, the tension in the web 102 drives the first cross bar 140 back against the second cross bar 142, thereby “locking” the web 102 in position and maintaining the tension in the first and second webs 102 and 104. To release the tension and increase the overall length of the first and second webs 102 and 104 so that, for example, the child seat 330 can be removed from the car seat 332, the user can rotate the cover 130 (and the release member 120) upwardly in direction R. When this happens, it enables the second cross bar 142 to slide forward in the slot portions 119a,b away from the first cross bar 140, thereby increasing the space therebetween and enabling the free end portion 102a to slide back between the first cross bar 140 and the second cross bar 142 to reduce the tension in the first web 102 (and consequently, the second web 104).

There are a number of advantages associated with some embodiments of the web adjuster 100. For example, the mechanical advantage of the release member 120 and the configuration of the cam surface portions 126a,b (FIG. 1B) can reduce the force required to release the tension in the webs 102 and 104, even when the webs 102 and 104 are under substantial tension. In contrast, conventional push-button type web adjusters often have fixed locking surfaces that require the user to apply a release force equal to, or at least approximately equal to, the tension in the webs to effect release. Similarly, conventional tilt lock designs typically require rotation of the entire web adjuster to effect release, which can require significant force when the system is under substantial tension.

References throughout the foregoing description to features, advantages, or similar language do not imply that all of the features and advantages that may be realized with the present technology should be or are found in any single embodiment of the present technology. Rather, language referring to the features and advantages is understood to mean that a specific feature, advantage, or characteristic described in connection with an embodiment is included in at least one embodiment of the present technology. Thus, discussion of the features and advantages, and similar language, throughout this specification may, but do not necessarily, refer to the same embodiment. One skilled in the relevant art will also recognize that the present technology can be practiced without one or more of the specific features or advantages of a particular embodiment. In other instances, additional features and advantages may be recognized in certain embodiments that may not be present in all embodiments of the present technology.

Any patents and applications and other references noted above, including any that may be listed in accompanying filing papers, are incorporated herein by reference. Aspects of the invention can be modified, if necessary, to employ the systems, functions, and concepts of the various references described above to provide yet further implementations of the invention.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof means any connection or coupling, either direct or indirect, between two or more elements. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

While the above description describes various embodiments of the invention and the best mode contemplated, regardless how detailed the above text, the invention can be practiced in many ways. Details of a system may vary considerably in its specific implementation, while still being encompassed by the present disclosure. As noted above, particular terminology used when describing certain features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed in the specification, unless the above Detailed Description section explicitly defines such terms. Accordingly, the actual scope of the invention encompasses not only the disclosed examples, but also all equivalent ways of practicing or implementing the invention under the claims. Accordingly, the invention is not limited, except as by the appended claims.

Although certain aspects of the invention are presented below in certain claim forms, the applicant contemplates the various aspects of the invention in any number of claim forms. Accordingly, the applicant reserves the right to pursue additional claims after filing this application to pursue such additional claim forms, in either this application or in a continuing application.

I/we claim:

1. A web adjuster for use with a web, the web adjuster comprising:
a frame;
a first cross bar operably coupled to the frame;
a second cross bar operably coupled to the frame, wherein the first and second bars are configured to be positioned with the web in a gap therebetween; and
a release member pivotably coupled to the frame, wherein movement of the release member in a first direction enables the second cross bar to move away from the first cross bar to increase the gap therebetween, and wherein movement of the release member in a second direction, opposite to the first direction, drives the second cross bar back toward the first cross bar to reduce the gap therebetween.

2. The web adjuster of claim 1:
wherein the release member includes at least one cam surface portion,
wherein movement of the release member in the first direction moves the cam surface portion away from the second cross bar and enables the second bar to move away from the first cross bar, and
wherein movement of the release member in the second direction moves the cam surface portion toward the second cross bar and drives the second cross bar back toward the first cross bar.

3. The web adjuster of claim 1 the second cross bar is slidably coupled to the frame.

4. The web adjuster of claim 1 wherein the first cross bar and the second cross bar are slidably coupled to the frame.

5. The web adjuster of claim 1:
wherein the frame includes a first side wall spaced apart from a second side wall,
wherein the first side wall includes a first slot portion and the second side wall includes a second slot portion, and
wherein the second cross bar includes a first end portion slidably received in the first slot portion and a second end portion slidably received in the second slot portion.

6. The web adjuster of claim 5 wherein the first and second end portions of the second cross bar have generally rectangular shapes configured to slide back and forth in the first and second slot portions, respectively.

7. The web adjuster of claim 1:
wherein the frame includes a first side wall spaced apart from a second side wall,
wherein the first side wall includes a first slot portion adjacent to a third slot portion,
wherein the second side wall includes a second slot portion adjacent to a fourth slot portion,
wherein the first cross bar includes a first end portion slidably received in the first slot portion a second end portion slidably received in the second slot portion, and
wherein the second cross bar includes a first end portion slidably received in the third slot portion and a second end portion slidably received in the fourth slot portion.

8. The web adjuster of claim 7 wherein the third slot portion is offset from the first slot portion, and the fourth slot portion is offset from the second slot portion.

9. The web adjuster of claim 1:
wherein the frame includes a first side wall spaced apart from a second side wall,
wherein the release member is pivotally coupled to the frame and includes a first cam surface portion spaced apart from a second cam surface portion,
wherein rotation of the release member in the first direction moves the first and second cam surface portions away from the second cross bar and enables the second cross bar to move away from the first cross bar, and
wherein rotation of the release member in the second direction moves the first and second cam surface portions toward the second cross bar and drives the second cross bar back toward the first bar.

10. The web adjuster of claim 9:
wherein the release member further includes a first side flange pivotally coupled to the first side wall and a second side flange pivotally coupled to the second side wall, and
wherein the first side flange includes the first cam surface portion and the second side flange includes the second cam surface portion.

11. A restraint system comprising:
a web;
a web adjuster, wherein the web adjuster includes
a frame having a base extending between a first side wall and a second side wall, wherein base includes a web aperture;
a first cross bar having a first end portion movably coupled to the first side wall and a second end portion movably coupled to the second side wall;
a second cross bar having a first end portion movably coupled to the first side wall and a second end portion movably coupled to the second side wall; and
a release member pivotally coupled to the first side wall and the second side wall,
wherein the web extends through the web aperture and between the first and second cross bars,
wherein rotation of the release member away from the base toward a release position enables the second cross bar to move away from the first cross bar and the web to pass therebetween, and
wherein rotation of the release member away from the release position toward the base drives the second cross bar back toward the first cross bar and the web therebetween.

12. The restraint system of claim 11 wherein the release member includes a surface portion configured to contact the second cross bar and drive the second cross bar toward the first cross bar when the release member is rotated toward base.

13. The restraint system of claim 12 wherein the surface portion is positioned between the first and second sidewalls.

14. The restraint system of claim 11 wherein a portion of the second cross bar has a cylindrical cross section, and wherein the release member includes at least one surface portion having a concave rounded shape configured to contact the cylindrical cross section.

15. The restraint system of claim 11:
wherein the release member includes a first side flange pivotally coupled to the first side wall and a second side flange pivotally coupled to the second side wall,
wherein the first side flange includes a first cam surface portion configured to cooperate with a first portion of the second cross bar, and the second side flange includes a second cam surface portion configured to cooperate with a second portion of the second cross bar,
wherein rotation of the release member away from the base moves the first and second cam surface portions away from the second cross bar and enables the second cross bar to move away from the first cross bar, and
wherein rotation of the release member toward the base brings the first and second cam surface portions into contact with the second cross bar and drives the second cross bar back toward the first cross bar.

16. The restraint system of claim 15:
wherein the web is a first web and the restraint system further comprises a second web,
wherein the web aperture is a first web aperture and the frame further includes a second web aperture,
wherein the first web extends through the first and second web apertures, and
wherein the second web extends through the second web aperture and is attached to itself to secure the frame to the second web.

17. The restraint system of claim 11 wherein the web is a first web that extends away from the web adjuster in a first direction, and wherein the restraint system further comprises a second web that passes through the web aperture and extends away from the web adjuster in a second direction, opposite to the first direction.

18. The restraint system of claim 17:
wherein the first web includes a free end portion,
wherein the release member is rotatable between the release position spaced apart from the base and a locked position proximate the base,
wherein pulling the free end portion of the first web when the release member is in the locked position increases tension in the first and second webs, and
wherein releasing the free end potion after increasing the tension in the first and second webs causes the tension in the first web to drive the first cross bar toward the second cross bar and clamp the first web therebetween.

19. The restraint system of claim 11 wherein the first end portion of the second cross bar is slidably coupled to the first side wall and the second end portion of the second cross bar is slidably coupled to the second side wall.

20. The restraint system of claim 11:
wherein the first end portion of the first cross bar is slidably coupled to the first side wall and the second end portion of the first cross bar is slidably coupled to the second side wall, and
wherein the first end portion of the second cross bar is slidably coupled to the first side wall and the second end portion of the second cross bar is slidably coupled to the second side wall.
